(19) United States
(12) Patent Application Publication
(10) Pub. No.: US 2014/0348581 A1
(43) Pub. Date: Nov. 27, 2014

(54) Mounting System for a Vehicle and Method of Using the Same

(71) Applicant: Soucy International Inc., Drummondville (CA)

(72) Inventors: Jimmy BOUTIN, Upton (CA); Normand Roy, St-Hugues (CA); Mathieu VINCENT, Drummondville (CA); Philippe JAILLET-GOSSELIN, Drummondville (CA); Geneviève THERRIEN, Drummondville (CA); Vincent MORIN, Saint-Hyacinthe (CA); Julie TREMBLAY, Drummondville (CA)

(73) Assignee: Soucy International Inc., Drummondville (CA)

(21) Appl. No.: 14/286,152

(22) Filed: May 23, 2014

Related U.S. Application Data
(60) Provisional application No. 61/827,327, filed on May 24, 2013.

(51) Int. Cl. B60R 9/00

(52) U.S. Cl. CPC B60R 9/00
USPC 403/376; 29/428

(57) ABSTRACT

A mounting system for mounting an accessory to a vehicle is disclosed. The mounting system generally comprises a receiving hub configured to be secured to the vehicle, typically to the handlebar thereof, and a mounting element, mounted to, or integral with, the accessory, configured to be releasably received into the receiving hub. The receiving hub generally comprises an internal receiving cavity configured to receive a male portion of the mounting element.

### CROSS-REFERENCE TO RELATED APPLICATIONS

The present patent application claims the benefits of priority of U.S. Provisional Patent Application No. 61/827,327, entitled “Mounting System for a Vehicle and Method of Using the Same”, and filed at the United States Patent and Trademark Office on May 24, 2013, the content of which is incorporated herein by reference.

### FIELD OF THE INVENTION

The present invention generally relates to assemblies and/or systems for mounting accessories to vehicles. More particularly, the invention relates to assemblies and/or systems for mounting accessories to typically straddle-type vehicles (e.g. all-terrain vehicles (“ATVs”), snowmobiles, motorcycles, etc.).

### BACKGROUND OF THE INVENTION

Nowadays, there are an ever-increasing number of people which enjoy riding all-terrain vehicles, snowmobiles, and other similar off-road vehicles, either in trails specifically designed for this activity or even on totally uncharted terrain.

Such vehicles are often used to perform different kinds of works and/or used in different environments. It is thus generally desirable to be able to easily install and remove accessories to such vehicles. However, most accessories often have to be installed using special mounting kits or assemblies.

There is thus a need for a mounting system which allows the installation and removal of an accessory to a vehicle.

### SUMMARY OF THE INVENTION

A mounting system in accordance with the principles of the present invention generally comprises a receiving hub configured to be mounted to a vehicle, typically the handlebar thereof, and a mounting element mounted to, or integral with, the accessory, and configured to be releasably received in the receiving hub.

The receiving hub (“the hub” or “the receiving hub”) generally comprises two main portions, a vehicle attachment portion and a hub portion extending therefrom. Understandably, the vehicle attachment portion is configured to secure the hub to the vehicle, typically but not exclusively to the handlebar thereof.

For its part, the hub portion, which extends from the vehicle attachment portion, generally comprises a housing comprising a front opening and an internal cavity which are configured to releasably receive the substantially complementary male portion of the mounting element.

The mounting element generally comprises a support portion and the male portion already introduced, the male portion extending from the support portion. The support portion is adapted to support, or is integrated with, the accessory destined to be mounted to the vehicle. Understandably, different accessories may warrant different configurations of support portions.

In typical yet non-limitative embodiments, the mounting element comprises a locking mechanism configured to releasably engage a locking region on the hub portion of the hub.

In typical yet non-limitative embodiments, the internal cavity of the hub portion comprises several grooves configured to receive resilient protrusions outwardly extending from the male portion of the mounting element. The resilient protrusions are generally configured to reduce the amount of vibration between the male portion and the hub portion when the male portion is received into the internal cavity.

In use, the hub is typically already mounted to the vehicle, typically to the handlebar thereof, and the mounting element typically already supports the accessory to be mounted to the vehicle.

To mount the accessory to the vehicle, the male portion of the mounting element is inserted into the cavity of the hub portion. In typical embodiments, once the male portion is properly received, the locking mechanism of the mounting element engages the locking region of the hub portion.

To remove the accessory, the locking mechanism is actuated such as to disengage the locking region of the hub portion and the mounting element is withdrawn from the hub portion, generally by pulling on the mounting element and/or on the accessory.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a front perspective view of the front portion of a vehicle having mounted thereto an accessory using a mounting system in accordance with the principles of the present invention.

FIG. 2 is a rear perspective view of the front portion of the vehicle of FIG. 1.

FIG. 3 is a front perspective view of the front portion of the vehicle of FIG. 1, with the accessory shown dismounted from the vehicle.

FIG. 4 is a rear perspective view of the front portion of the vehicle of FIG. 1, with the accessory shown dismounted from the vehicle.

FIG. 5 is a side view of the mounting system in accordance with the principles of the present invention.

FIG. 6 is a side view of the mounting system of FIG. 5, with the accessory shown dismounted.

FIG. 7 is a front top perspective view of the hub of the mounting system.

FIG. 8 is a front bottom perspective view of the hub of FIG. 7.

FIG. 9 is a rear exploded perspective view of the hub of FIG. 7.

FIG. 10 is a rear top perspective view of the mounting element of the mounting system, shown supporting an accessory.

FIG. 11 is a side view of the mounting element of FIG. 10.

FIG. 12 is a top view of the mounting element of FIG. 10.

FIG. 13 is a cross-sectional side view of the mounting system.

FIG. 14 is a cross-sectional perspective view of the mounting system of FIG. 13.

FIG. 15 is another cross-sectional side view of the mounting system of FIG. 13.

### DETAILED DESCRIPTION OF THE PREFERRED EMBODIMENT

A novel system for mounting an accessory to a vehicle and a method of using the same will be described hereinafter. Although the invention is described in terms of specific illustrative embodiments, it is to be understood that the embodiments described herein are by way of example only and that the scope of the invention is not intended to be limited thereby.

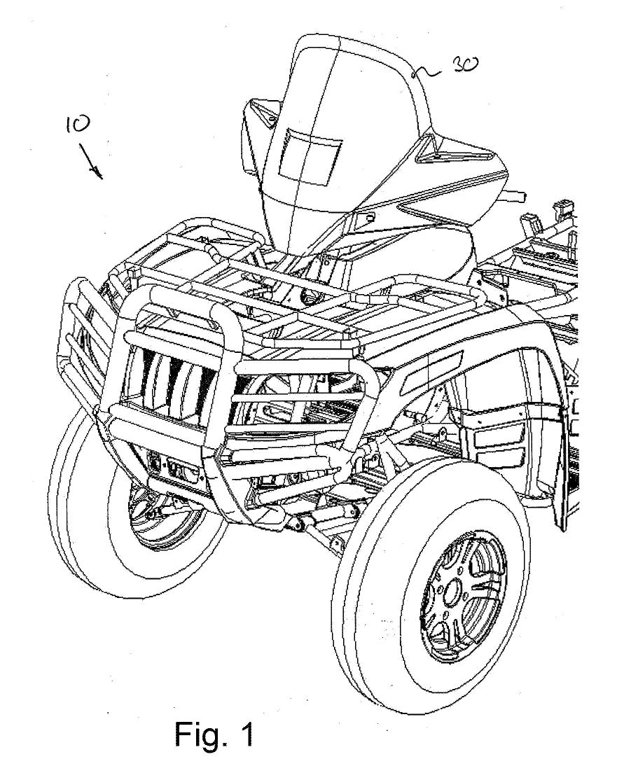

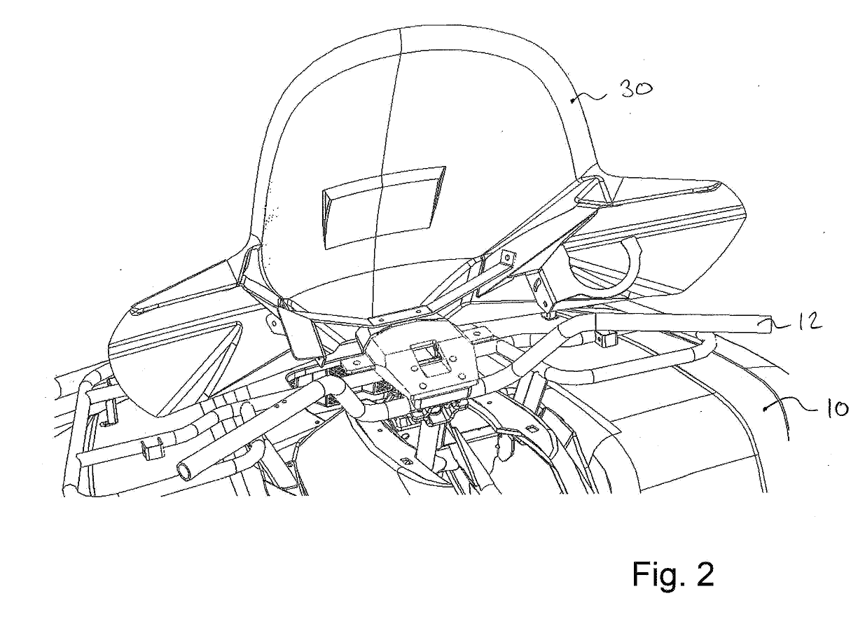

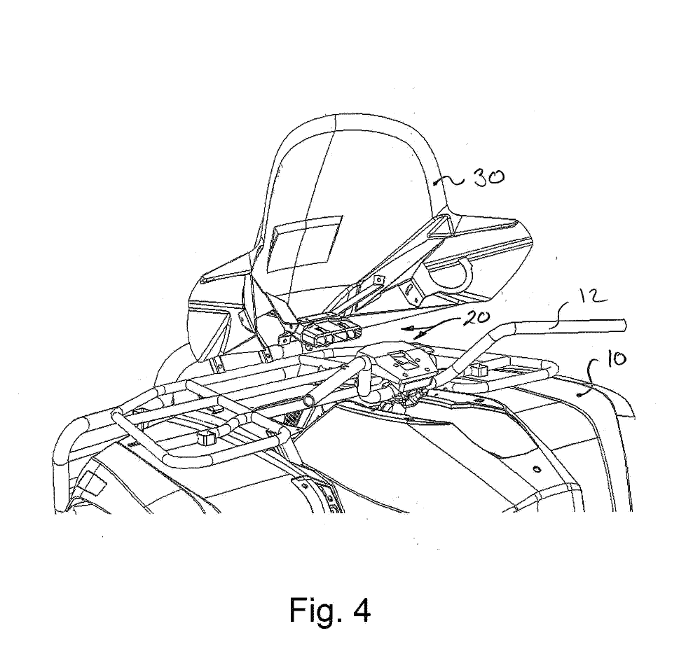

Referring first to FIGS. 1 to 4, an accessory (e.g. a windshield) 30 is shown mounted to a vehicle (e.g. an ATV) 10 using an embodiment of a mounting system 20 in accordance with the principles of the present invention.

Though the vehicle 10 shown in FIGS. 1 to 4 is an ATV, other types of vehicles are possible. For instance, snowmobiles, motorcycles, etc. In that sense, the mounting system 20 in accordance with the principles of the present invention is particularly, but not necessarily, adapted for use on vehicles which steering is effected by rotating a handlebar or a similar steering mechanism. Such vehicles often are straddle-type vehicles.

Also, though the accessory 30 shown in the figures is a windshield, the support portion 250 of the mounting element 200, described in more details below, could understandably support other accessories (e.g. lights, hand guards, etc.).

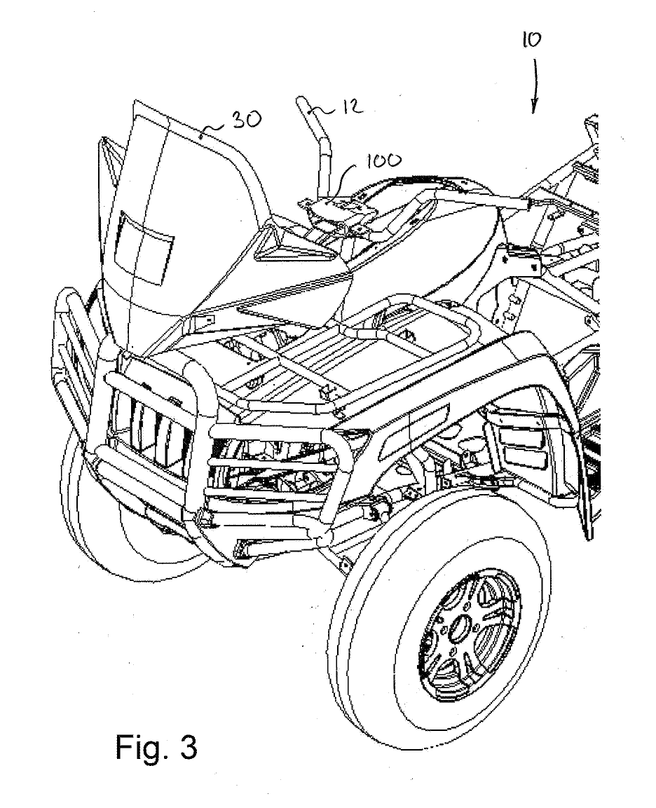

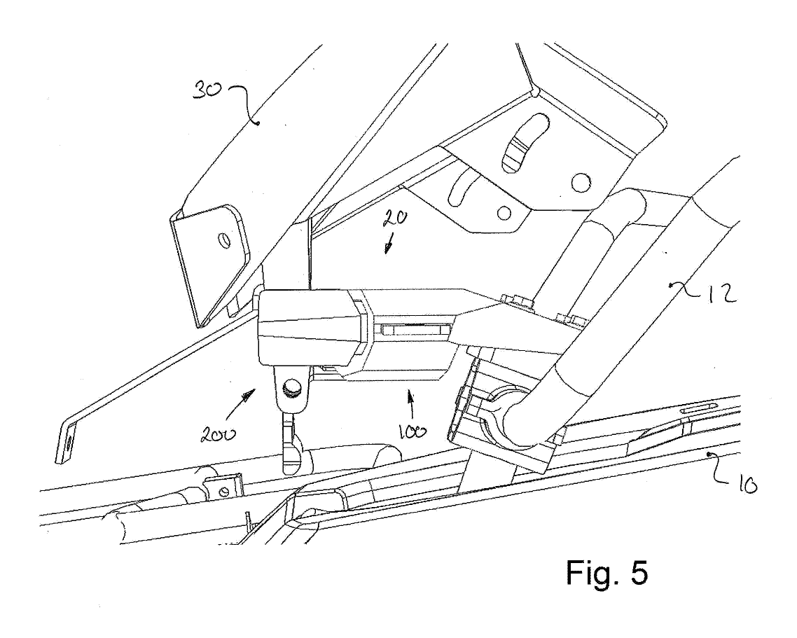

Referring now to FIGS. 3 to 6, the mounting system 20 generally comprises a receiving hub 100 configured to be mounted to the vehicle 10, and a mounting element 200 configured to support the accessory 30 and to be releasably mounted to the hub 100.

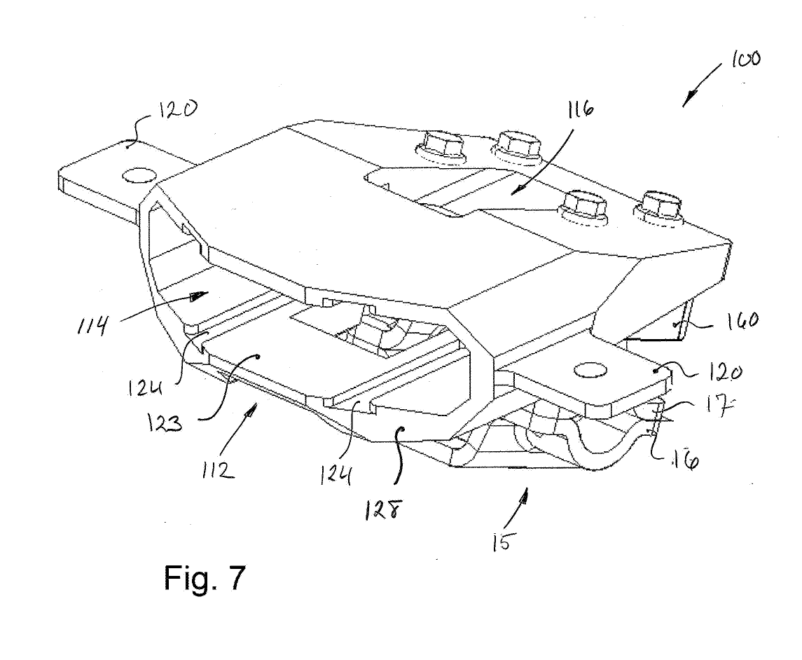

Referring now to FIGS. 7 to 9, the hub 100 will be described in more details.

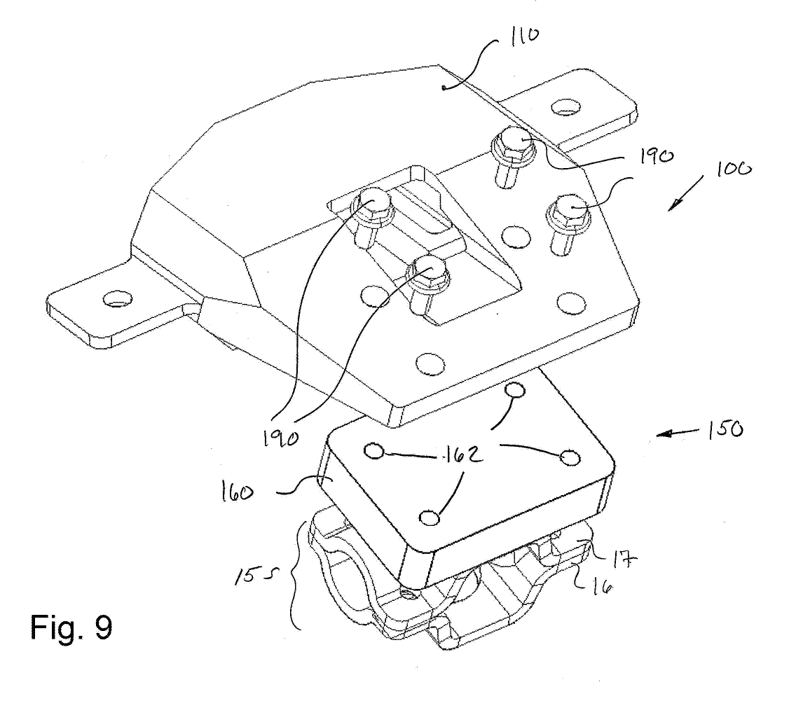

The hub 100 generally comprises a hub portion 110 and an attachment portion 150. In the present embodiment, the hub portion 110 is secured to the attachment portion 150 via a series of bolts 190 (see FIG. 9).

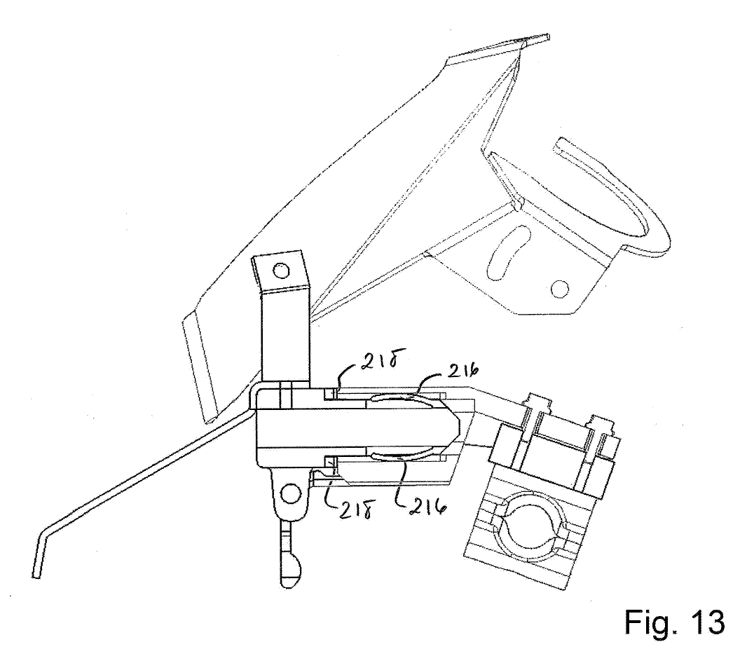

The hub portion 110 is configured to receive the male portion 210 of the mounting element 200 (see FIG. 13). In that sense, the hub portion 110 comprises a typically front-facing opening 112 and an internal cavity 114. Understandably, the internal cavity 114 is shaped such as to receive therein the male portion 210 which shape is substantially complementary.

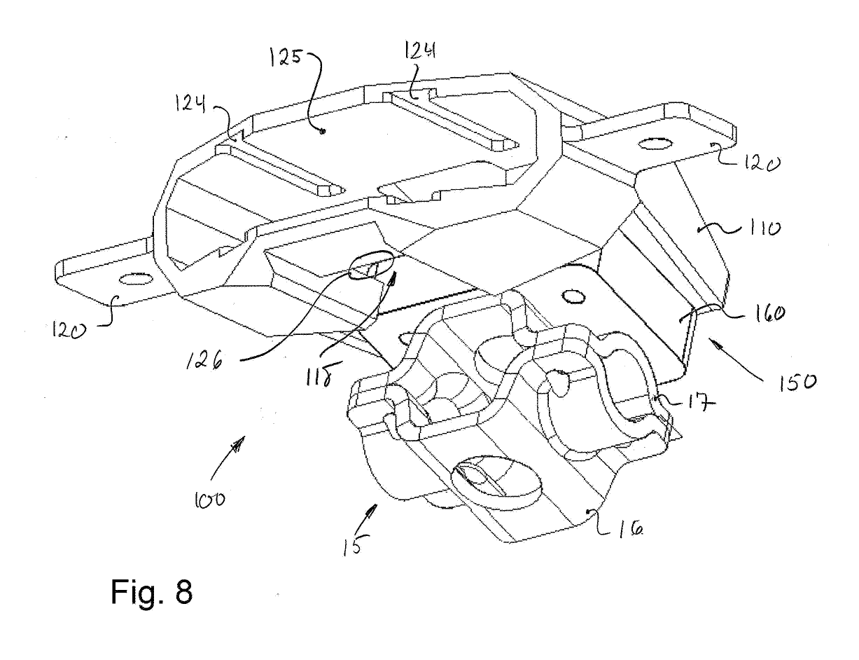

As best shown in FIGS. 7 and 8, in the present embodiment, the opening 112 and the cavity 114 extend substantially laterally. Also, in the present embodiment, when viewed from the front, the opening 112 and the cavity 114 are generally polygonal in shape.

Understandably, in other embodiments, the shape of the opening 112 and the cavity 114 could be other than polygonal. For example, the opening 112 and the cavity 114 could be oval.

As illustrated in FIGS. 7 and 8, the hub portion 110 also comprises top and bottom openings 116 and 118 respectively located in the top and bottom wall portions 115 and 117 of the hub portion 110. The top opening 116 allows the passage of electrical wires if necessary. For its part, the bottom opening 118 also allows the passage of electrical wires if necessary and also provides a locking region 126 which will be described below.

Though not shown in the present embodiment, the cavity 114 could comprise an electrical connector connected, or connectable, to a source of electrical power (e.g. the vehicle battery) such as to be able to provide electrical power to an electrical accessory (e.g. a light). In such embodiment, the male portion 210 of the mounting element 200 would comprise a complementary electrical connector that would connect to the electrical connector of the cavity 114 upon being received into the cavity 114.

In the present embodiment, the hub portion 110 also comprises mounting lugs 120 extending on each side as best shown in FIGS. 7 and 8. These mounting lugs 120 are configured to provide attachment locations for the pod envelop or shell (not shown). In other embodiments, these mounting lugs 120 could provide additional attachment locations if such additional attachment locations are necessary because of the particular configuration or weight of the accessory 30. Other embodiments could possibly be devoid of such mounting lugs 120.

As indicated above, the hub portion 110 is secured to the attachment portion 150 which is configured to be mounted to the vehicle 10.

In the present embodiment, the attachment portion 150 is configured to be mounted to the handlebar 12 of the vehicle 10. In that sense, the attachment portion 150 comprises a support block 160 which is configured to be mounted to the upper clamping member 17 of the clamping assembly 15 of the vehicle. The support block 160 provides attachment locations 162 for the hub portion 110 and also raises the overall height of the hub assembly 100. In that sense, different support blocks 160 having different heights could be used to provide the properly raise the hub portion 110.

Understandably, in other embodiments, the support block 160 could be integral with the hub portion 110 such that the hub portion 110 would be directly mounted to the upper clamp member 16. In still other embodiments, the support block 160 could be absent altogether. In such embodiments, the hub portion 110 would be mounted directly to the handlebar 12, typically to the clamping assembly 15 thereof

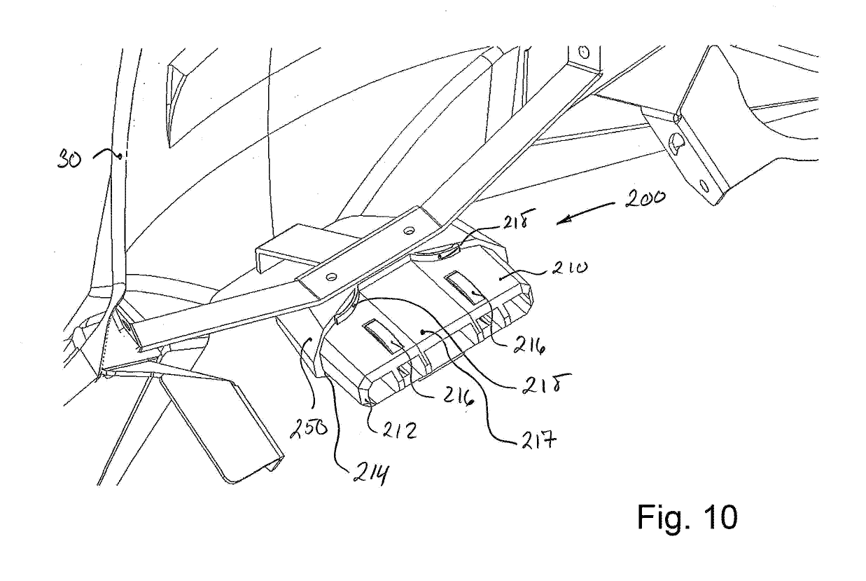

Referring now to FIGS. 10 to 12, the mounting element 200 of the mounting system 20 will be described in more details.

The mounting element 200 generally comprises the male portion 210 and a support portion 250 from which extends the male portion 210.

As indicated above, the male portion 210 is configured to be received into the internal cavity 114 of the hub portion 110. In that sense, the male portion 210 is shaped to be substantially complementary with the shape of the opening 112 and of the internal cavity 114.

The free end 212 of the male portion 210 is typically tapered to ease the insertion of the male portion 210 into the cavity 114.

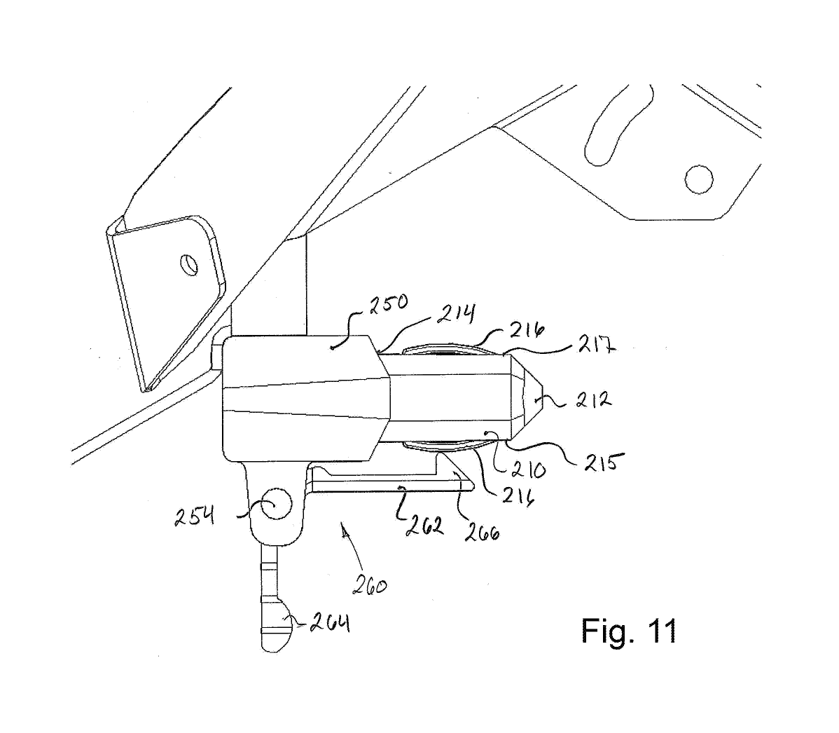

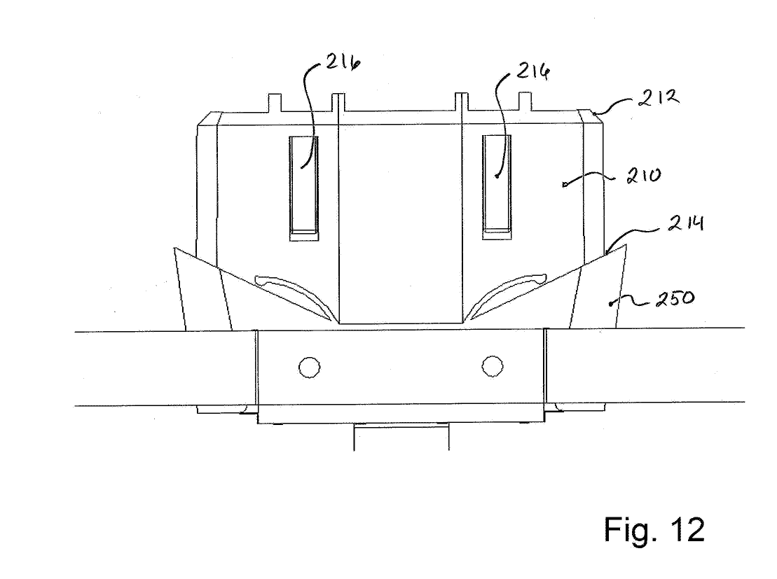

As best shown in FIGS. 11 and 12 (see also FIG. 10), the male portion 210 defines a shoulder 214 with the support portion 250. The shoulder 214 generally limits the insertion of the male portion 210 into the cavity 114. In that sense, the shoulder 214 is typically configured to abut on the rim 128 of the opening 112 of the hub portion 110 (see FIGS. 13-15).

Though not shown in the figures, the male portion 210 could comprise the electrical connector introduced above if the accessory to be mounted to the vehicle 10 needs an electrical source.

Referring now to FIGS. 7-8 and 10-14, in the present embodiment, the internal cavity 114 of the hub portion 110 further comprises internal grooves 124, and the male portion 210 of the mounting member 200 further comprises outwardly extending resilient protrusions or bumps 216. In the present embodiment, the hub portion 110 generally comprises two lower grooves 124 located in the lower wall portion 123 of the internal cavity 114 (see FIG. 7) and two upper grooves 124 located in the upper wall portion 125 of the internal cavity 114 (see FIG. 8). Similarly, the male portion 210 comprises two lower protrusions 216 located on the lower wall portion 215 of the male portion 210 and two upper protrusions 216 located on the upper wall portion 217 of the male portion 210 (see FIGS. 10 and 11).

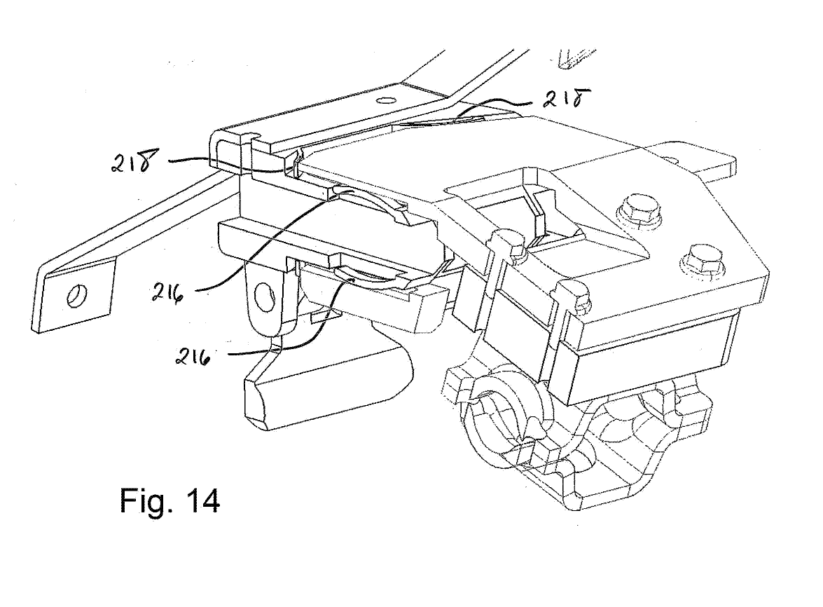

As best shown in FIGS. 13 and 14, the grooves 124 are configured to slidingly receive the resilient protrusions 216. In use, the resiliency of the protrusions 216 generally reduces the level of vibration between the mounting element 200 and the hub 100.

To further reduce the level of vibration, the shoulder 214 between the male portion 210 and the support portion 250 may also comprise similar resilient protrusions or members 218. As shown in FIGS. 13 and 14, these resilient members 218 would abut on the rim 128 of the opening 112 of the hub portion 110.

Referring back to FIGS. 10 to 12, the support portion 250 of the mounting element 200 is generally adapted to support the accessory 30. Understandably, different types of accessories 30 may warrant different configurations for the support portion 250.

In other embodiments, the support portion 250 could be made integral with the accessory 30.

In the present embodiment, the support portion 250 further comprises a locking member 260 pivotally mounted thereto at 254. The locking member 260 comprises a locking portion 262 and a handle portion 264. The locking portion 262 is terminated by a locking hook 266 configured to engage the locking region 126 located adjacent the opening 118 of the hub portion 110 (see FIG. 8).

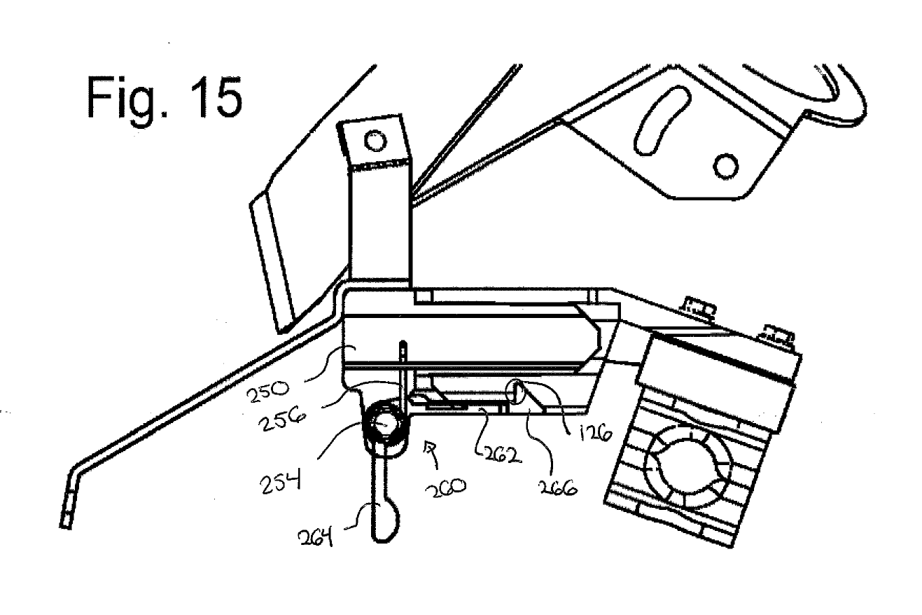

As best shown in FIG. 15, the pivotal connection 254 between the locking element 260 and the support portion 250 typically comprises a biasing mechanism (e.g. a torsion spring) 256 configured to bias the locking element 260 into its locked position. To unlock the locking element 260, the human operator needs to pivot the locking element 260 via the handle portion 264 such as to overcome the bias of the biasing mechanism 256.

In use, the hub 100 would typically already be installed to the vehicle 10, typically to the handlebar 12 thereof. Similarly, the mounting element 200 would already support the accessory 30 destined to be mounted to the vehicle 10.

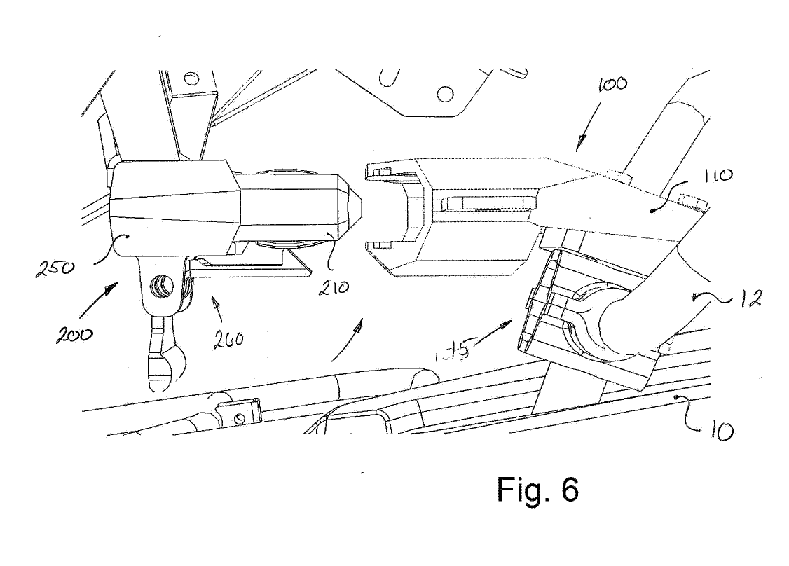

Referring to FIG. 6, to mount the accessory 30 to the vehicle 10, the human operator would insert (or push) the male mounting portion 210 of the mounting element 200 into the cavity 114 of the hub portion 110 until the shoulder 214, or the resilient members 218, abut on the rim 128 of the opening 112. At this point, the locking member 260 of the support portion 250 would lockingly engage the locking region 126 of the hub portion 110.

Still referring to FIG. 6, to remove the accessory 30 to the vehicle 10, the human operator would actuate the handle portion 264 of the locking element 260 such as to pivot the locking element 260 and disengage the locking hook 266 from the locking region 126. Then, the human operator would slide out (or pull) the mounting element 200 from the hub portion 110.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A mounting system for mounting an accessory to a vehicle, the mounting system comprising:
a) a receiving hub configured to be mounted to the vehicle, the receiving hub comprising a receiving cavity and a locking region;
b) a mounting element configured to be located on the accessory, the mounting element comprising a support portion and a mounting portion, the mounting portion being configured to be slidingly received into the receiving cavity of the receiving hub, the mounting element comprising a locking mechanism configured to releasably yet lockingly engage the locking region of the receiving hub when the mounting portion is received into the receiving cavity.

2) A mounting system as claimed in claim 1, wherein the receiving cavity comprises a plurality of grooves, and wherein the mounting portion comprises a plurality of resilient protrusions, the plurality of grooves being configured to receive the plurality of resilient protrusions.

3) A mounting system as claimed in claim 2, wherein the receiving cavity comprises an upper wall region, a lower wall region, a first side wall region and a second side wall region, and wherein the plurality of grooves are located in at least one of the upper and lower wall regions.

4) A mounting system as claimed in claim 3, wherein the mounting portion comprises an upper wall region, a lower wall region, a first side wall region and a second side wall region, and wherein the plurality of resilient protrusions are located in at least one of the upper and lower wall regions.

5) A mounting system as claimed in claim 1, wherein the receiving cavity comprises at least one upper groove and at least one lower groove, and wherein the mounting portion comprises at least one upper resilient protrusion and at least one lower resilient protrusion, the at least one upper and lower grooves being configured to respectively receive the at least one upper and lower resilient protrusions.

6) A mounting system as claimed in claim 1, wherein the receiving cavity defines a rim and wherein the support portion and mounting portion define a shoulder.

7) A mounting system as claimed in claim 6, wherein the shoulder comprises at least one resilient member extending outwardly therefrom, the at least one resilient member being configured to abut on the rim of the receiving cavity when the mounting portion is received into the receiving cavity.

8) A mounting system as claimed in claim 6, wherein the shoulder comprises a plurality of resilient members extending outwardly therefrom, the plurality of resilient members being configured to abut on the rim of the receiving cavity when the mounting portion is received into the receiving cavity.

9) A mounting system as claimed in claim 1, wherein the receiving hub comprises at least one opening extending to the receiving cavity.

10) A mounting system as claimed in claim 9, wherein the at least one opening is located in an upper portion of the receiving hub.

11) A mounting system as claimed in claim 9, wherein the at least one opening is located in a lower portion of the receiving hub.

12) A mounting system as claimed in claim 11, wherein the locking region is adjacent the at least one opening.

13) A vehicle having mounted thereto an accessory using a mounting system as claimed in claim 1.

14) A mounting system for mounting an accessory to a vehicle, the mounting system comprising:
a) a receiving hub configured to be mounted to the vehicle, the receiving hub comprising a receiving cavity and a locking region, the receiving cavity comprising a plurality of grooves;
b) a mounting element configured to be located on the accessory, the mounting element comprising a support portion and a mounting portion, the mounting portion being configured to be slidingly received into the receiving cavity of the receiving hub, the mounting portion comprising a plurality of resilient protrusions configured to be received in the plurality of grooves, the mounting element comprising a locking mechanism configured to releasably yet lockingly engage the locking region of the receiving hub when the mounting portion is received into the receiving cavity.

15) A mounting system as claimed in claim 14, wherein the receiving cavity comprises an upper wall region, a lower wall region, a first side wall region and a second side wall region, and wherein the plurality of grooves are located in at least one of the upper and lower wall regions.

16) A mounting system as claimed in claim 15, wherein the mounting portion comprises an upper wall region, a lower wall region, a first side wall region and a second side wall region, and wherein the plurality of resilient protrusions are located in at least one of the upper and lower wall regions.

17) A mounting system as claimed in claim 14, wherein the plurality of grooves comprises at least one upper groove and at least one lower groove, and wherein the plurality of resilient protrusions comprises at least one upper resilient protrusion and at least one lower resilient protrusion, the at least one upper and lower grooves being configured to respectively receive the at least one upper and lower resilient protrusions.

18) A mounting system as claimed in claim 14, wherein the receiving cavity defines a rim and wherein the support portion and mounting portion define a shoulder.

19) A mounting system as claimed in claim 18, wherein the shoulder comprises at least one resilient member extending outwardly therefrom, the at least one resilient member being configured to abut on the rim of the receiving cavity when the mounting portion is received into the receiving cavity.

20) A mounting system as claimed in claim 18, wherein the shoulder comprises a plurality of resilient members extending outwardly therefrom, the plurality of resilient members being configured to abut on the rim of the receiving cavity when the mounting portion is received into the receiving cavity.

21) A mounting system as claimed in claim 14, wherein the receiving hub comprises at least one opening extending to the receiving cavity.

22) A mounting system as claimed in claim 21, wherein the at least one opening is located in an upper portion of the receiving hub.

23) A mounting system as claimed in claim 21, wherein the at least one opening is located in a lower portion of the receiving hub.

24) A mounting system as claimed in claim 21, wherein the locking region is adjacent the at least one opening.

25) A vehicle having mounted thereto an accessory using a mounting system as claimed in claim 14.

26) A method to install an accessory on a vehicle using an mounting system as claimed in claim 1, the accessory comprising the mounting element, the vehicle comprising the receiving hub, the method comprising inserting the mounting portion of the mounting element into the receiving cavity of the receiving hub until the locking mechanism lockingly engage the locking region.
